(19) United States
(12) Patent Application Publication
(10) Pub. No.: US 2011/0091785 A1
(43) Pub. Date: Apr. 21, 2011

(54) FLAT-PLATE SOLID OXIDE FUEL CELL

(76) Inventor: Takashi Miyazawa, Ibaraki (JP)

(21) Appl. No.: 12/934,118

(22) PCT Filed: Mar. 27, 2009
(86) PCT No.: PCT/JP2009/001389

§ 371 Date: Dec. 21, 2010

(30) Foreign Application Priority Data
Mar. 28, 2008 (JP) 2008-087831

(51) Int. Cl. H01M 8/24

(52) U.S. Cl. 429/465

(57) ABSTRACT

An object of the present invention is to provide a flat-plate solid oxide fuel cell which can prevent a crack from occurring in an outer peripheral portion of a solid electrolyte due to the action of stress. In order to achieve this object, the present invention provides a flat-plate solid oxide fuel cell having a fuel cell stack (10) in which a plurality of power generation cells (16), each of which has a fuel electrode layer (12) formed on one side of the disc-shaped solid electrolyte (11) and an oxidant electrode layer (13) formed on the other side thereof, are laminated by interposing a separator (2) between the power generation cells (16); and in which a disc-shaped fuel electrode current collector (14) is interposed between the separator and the fuel electrode layer and a disc-shaped oxidant electrode current collector (15) is interposed between the separator and the oxidant electrode layer, wherein the solid electrolyte (11) is arranged to project outward from an outer peripheral edge of the fuel electrode current collector (14) and the oxidant electrode current collector (15) over the entire periphery in such a manner that the length of the projecting portion is equal to or greater than 3/100 and equal to or less than 20/100 of the radius of the solid electrolyte (11).

### TECHNICAL FIELD

The present invention relates to a flat-plate solid oxide fuel cell which prevents a crack from occurring in a solid electrolyte due to the action of stress.

### BACKGROUND ART

In recent years, a fuel cell which directly converts the chemical energy of fuel to electrical energy has gained attention as a highly efficient and clean power generating apparatus. Currently, more attention has been paid to the development of not only a polymer electrolyte fuel cell (PEFC) available on the market but also a first generation phosphoric acid fuel cell (PAFC), a second generation molten-carbonate fuel cell (MCFC), and a third generation solid oxide fuel cell (SOFC). Above all, the solid oxide fuel cell (SOFC) has an operating temperature as high as 600° C. to 1000° C., can provide an efficient use of exhaust heat, is suitable for an application to large scale power generation, and thus can be used for a wide range of applications from home use of 1 kw to 10 kw and commercial use as an alternate thermal power plant.

As the solid oxide fuel cell, for example, as disclosed in Patent Document 1, there has been known a flat-plate solid oxide fuel cell which has a plurality of flat plate fuel cell stacks in which a plurality of power generation cells, each of which has an oxidant electrode layer (cathode) formed on one side of a flat plate solid electrolyte layer made of a ceramic oxide ion conductor such as a lanthanum gallate oxide and a fuel electrode layer (anode) formed on the other side thereof, are laminated in the plate thickness direction by interposing a separator between the power generation cells; and in which a fuel electrode current collector is interposed between the separator and the fuel electrode layer and an oxidant electrode current collector is interposed between the separator and the oxidant electrode layer.

In the flat-plate solid oxide fuel cell, at power generation, an oxidant gas (oxygen) is supplied as a reactant gas to an oxidant electrode layer side and a reformed gas (H₂, CO, CO₂, H₂O, etc.) obtained by reforming a fuel gas (town gas containing CH₄ etc.) by a reformer is supplied to a fuel electrode layer side. The oxidant electrode layer and the fuel electrode layer are configured as a porous layer so as to allow the reactant gas to reach the interface with the solid electrolyte layer.

Thus, in the power generation cell, the oxygen supplied to the oxidant electrode layer side reaches near the interface with the solid electrolyte layer through pores in the oxidant electrode layer, and receives electrons from the oxidant electrode layer to be ionized into oxide ions (O²⁻). Then, the oxide ions diffusively move through the solid electrolyte layer toward the fuel electrode layer. The oxide ions which reach near the interface with the fuel electrode layer react in this place with a reformed gas to produce a reaction product (H₂O, CO₂, and the like) and emit electrons to the fuel electrode layer. Note that the electrons generated by electrode reaction can be extracted as an electromotive force by an external load through a different route.

At this time, the solid electrolyte constituting the power generation cell requires an operating temperature as high as 600° C. to 1000° C. to diffusively move the oxide ions as described above and thus is heated from outside at start-up. Further, at power generation, the above described production of a reaction product involves an exothermic reaction and thus the central portion has the highest temperature. Here, the solid electrolyte is incorporated in the above described laminated structure of fuel cell stacks and is sandwiched between the fuel electrode current collector and the oxidant electrode current collector. Thus, thermal expansion is suppressed, compression stress acts on the central portion, and tensile stress acts on the outer peripheral portion in a circumferential direction.

Further, in the solid electrolyte, at power generation, deformation in the thickness direction that may occur due to the difference in thermal expansion coefficient between the fuel electrode layer and the oxidant electrode layer is inhibited by the fuel electrode current collector and the oxidant electrode current collector, and stress also acts in the thickness direction.

As a result, at power generation, the solid electrolyte may be broken by a crack in the outer peripheral portion due to the action of the tensile stress and the stress in the thickness direction.
Patent Document 1: Japanese Patent Laid-Open No. 2007-42442

### DISCLOSURE OF THE INVENTION

In view of the above, the present invention has been made, and an object of the present invention is to provide a flat-plate solid oxide fuel cell which can prevent a crack from occurring in an outer peripheral portion of a solid electrolyte due to the action of stress.

More specifically, the present invention provides a flat-plate solid oxide fuel cell having a fuel cell stack in which a plurality of power generation cells, each of which has a fuel electrode layer formed on one surface of a disc-shaped solid electrolyte and an oxidant electrode layer formed on the other surface thereof, are laminated by interposing a separator between the power generation cells; and in which a disc-shaped fuel electrode current collector is interposed between the separator and the fuel electrode layer; and a disc-shaped oxidant electrode current collector is interposed between the separator and the oxidant electrode layer, wherein the solid electrolyte is arranged to project outward from an outer peripheral edge of the fuel electrode current collector and the oxidant electrode current collector over the entire periphery in such a manner that the length of the projecting portion is equal to or greater than 3/100 and equal to or less than 20/100 of the radius of the solid electrolyte.

According to the flat-plate solid oxide fuel cell of the present invention, the solid electrolyte is arranged to project outward from an outer peripheral edge of the fuel electrode current collector and the oxidant electrode current collector over the entire periphery in such a manner that the length of the projecting portion is equal to or greater than 3/100 and equal to or less than 20/100 of the radius of the solid electrolyte. Therefore, this projecting portion can relieve stress such as tensile stress at power generation by being deformed without being constrained by the fuel electrode current collector and the oxidant electrode current collector.

Thus, the present invention can prevent a crack from occurring in an outer peripheral portion of a solid electrolyte due to the action of stress.

### BRIEF DESCRIPTION OF THE DRAWINGS

FIG. 1 is a perspective view for describing a configuration of a fuel cell stack 10 according to the present invention;

FIG. 2 is a side view of a power generation cell 16 of FIG. 1;

FIG. 3A is a plan view illustrating the configuration of the fuel cell stack 10;

FIG. 3B is a side view illustrating the configuration of the fuel cell stack 10;

FIG. 4 is a longitudinal sectional view of the flat-plate solid oxide fuel cell according to the present invention; and

FIG. 5 is a cross-sectional view of the same solid oxide fuel cell.

### DESCRIPTION OF SYMBOLS

2 Separator
2x Discharge outlet
2y Discharge outlet
10 Fuel cell stack
11 Solid electrolyte
11a Projecting portion
12 Fuel electrode layer
13 Oxidant electrode layer
14 Fuel electrode current collector
15 Oxidant electrode current collector
16 Power generation cell

### BEST MODE FOR CARRYING OUT THE INVENTION

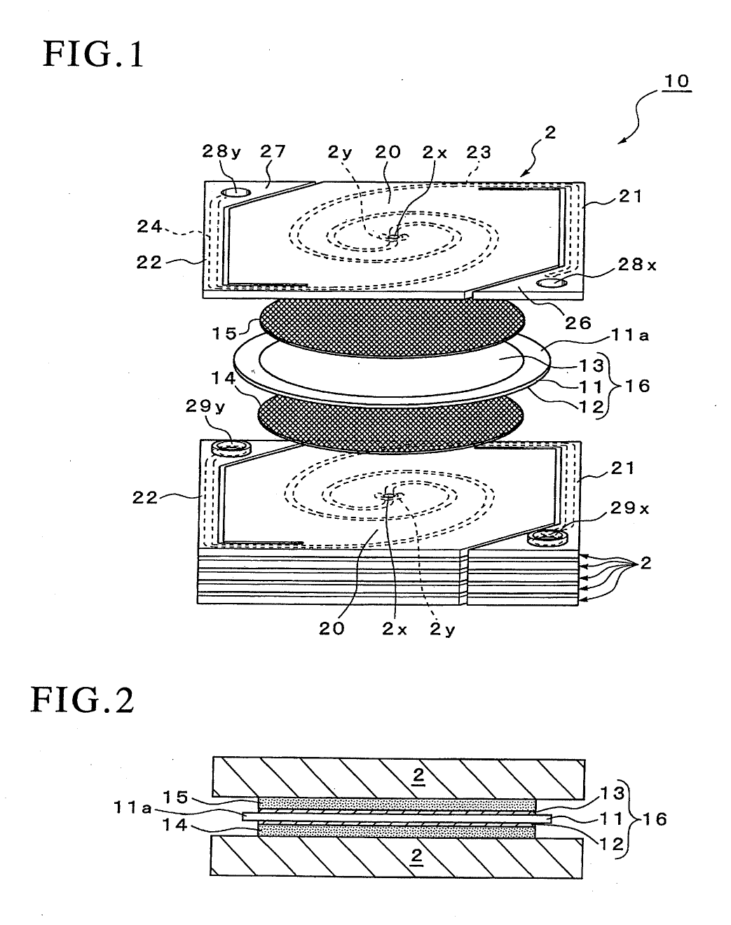

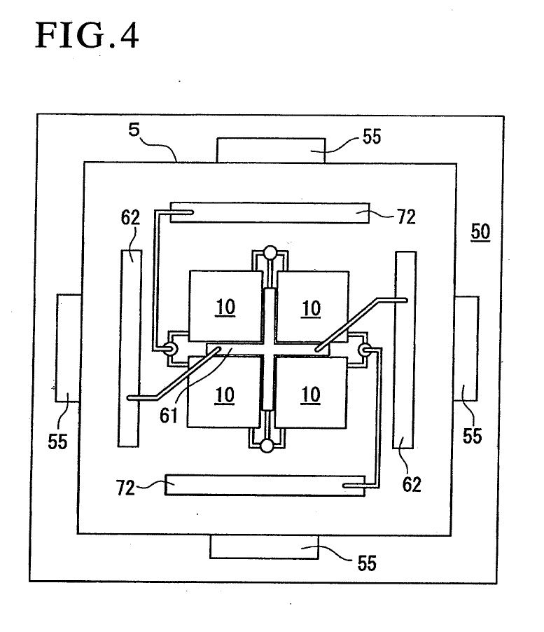

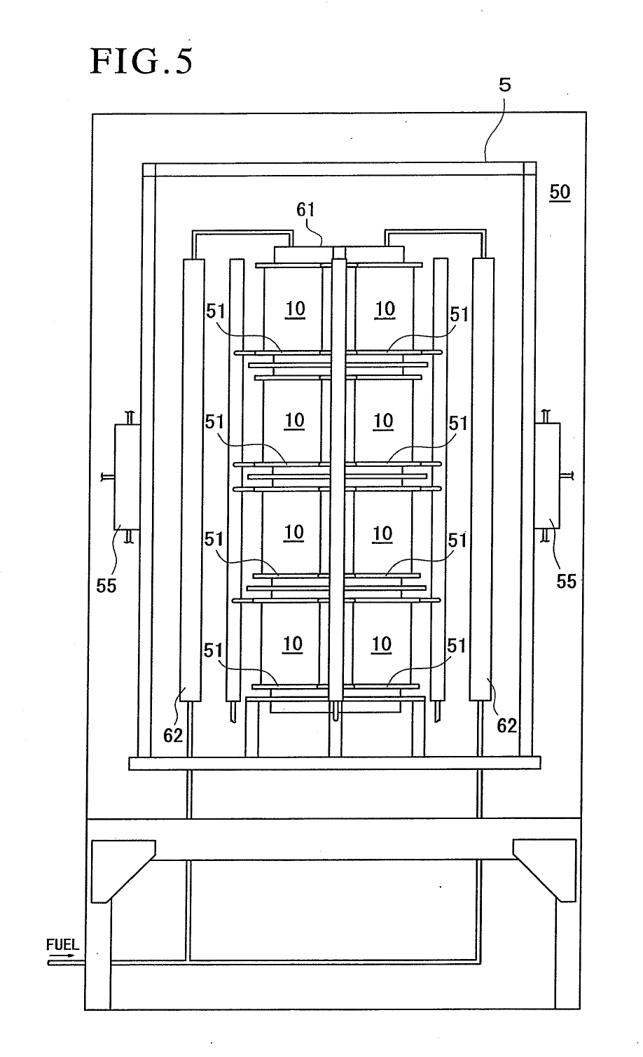

Hereinafter, embodiments of a flat-plate solid oxide fuel cell according to the present invention will be described by referring to FIGS. 1 to 5.

As illustrated in FIGS. 1 and 2, a fuel cell according to the present embodiment is configured to have a flat-plate fuel cell stack 10 which has an external appearance of a substantially rectangular columnar shape and in which a plurality of power generation cells 16, each of which has a fuel electrode layer 12 disposed on one surface of a disc-shaped solid electrolyte 11 and an oxidant electrode layer 13 disposed on the other surface thereof, are laminated in the plate thickness direction by interposing a separator 2 between the power generation cells, and in which a fuel electrode current collector 14 is interposed between the separator 2 and the fuel electrode layer 12; and an oxidant electrode current collector 15 is interposed between the separator 2 and oxidant electrode layer 13.

This solid electrolyte 11 is made of circular plate-like lanthanum gallate ceramics expressed by the composition formula La₁₋ₓSrₓGa_{1-y}Mg_{y}O₃ (X=0.05 to 0.3, Y=0.025 to 0.3) or La₁₋ₓSrₓGa_{1-y-z}Mg_{y}CO_{z}O₃ (X=0.05 to 0.3, Y=0 to 0.29, Z=0.01 to 0.3, Y+Z=0.025 to 0.3).

The fuel electrode layer 12 is made of a metal such as Ni or a cermet such as Ni-YSZ, Ni-SDC, and Ni-GDC. The oxidant electrode layer 13 is made of LaMnO₃, LaCoO₃, SrCoO₃, or the like.

The fuel electrode current collector 14 is made of a sponge-like porous sintered metal plate such as Ni and formed into a circular flat plate shape. The oxidant electrode current collector 15 is made of a sponge-like porous sintered metal plate such as Ag and formed into a circular flat plate shape. The current collectors 14 and 15 are formed to be slightly smaller than the solid electrolyte 11.

Briefly, the solid electrolyte 11 is sandwiched between the fuel electrode current collector 14 and the oxidant electrode current collector 15. Moreover, the solid electrolyte 11 is arranged to project outward from an outer peripheral edge of the current collectors 14 and 15 over the entire periphery in such a manner that the length of the projecting portion is equal to or greater than 3/100 and equal to or less than 20/100 of the radius of the solid electrolyte 11.

This is because if the projecting portion 11a is less than 3/100 of the radius of the solid electrolyte 11, thermal stress cannot be relieved enough to prevent a crack from occurring by deformation of the outer peripheral portion of the solid electrolyte 11; and if the projecting portion 11a exceeds 20/100 of the radius of the solid electrolyte 11, an electrical contact surface between the power generation cell 16 and the current collectors 14 and 15 becomes excessively small and thus the amount of electricity obtained by a reaction between the oxidant gas and the fuel gas is reduced remarkably.

The separator 2 is made of a substantially square stainless plate with a thickness of several mm and is configured to include: a central separator body 20 laminating the above described power generation cell 16 and each of the current collectors 14 and 15; and a pair of separator arms 21 and 22, each of which extends in a plane direction from the separator body 20 and supports a mutually facing edge portion of the separator body 20 at two positions.

The separator body 20 has a function of electrically connecting between the power generation cells 16 through the current collectors 14 and 15 as well as a function of supplying reactant gas to each power generation cell 16. The separator body 20 includes a fuel gas path 23 which introduces fuel gas from an edge portion of the separator 2 to the inside thereof and ejects the fuel gas from a discharge outlet 2x in a center portion of a surface facing the fuel electrode current collector 14 of the separator 2; and an oxidant gas path 24 which introduces oxidant gas from an edge portion of the separator 2 and ejects the oxidant gas from a discharge outlet 2y in a center portion of a surface facing the oxidant electrode current collector 15 of the separator 2.

Each of the separator arms 21 and 22 has a structure having flexibility in the lamination direction as a long strip shape extending along an outer periphery of the separator body 20 toward a mutually facing corner portion having a slight space therebetween and a pair of gas holes 28x and 28y penetrating through in the plate thickness direction are provided on end portions 26 and 27 of the separator arms 21 and 22.

One gas hole 28x is communicatively connected to the fuel gas path 23 of the separator 2 and the other gas hole 28y is communicatively connected to the oxidant gas path 24 of the separator 2, so as to supply fuel gas and oxidant gas to each surface of the respective electrodes 12 and 13 of each power generation cell 16 through the respective gas paths 23 and 24 from the respective gas holes 28x and 28y.

Then, a power generation cell 16 and current collectors 14 and 15 are interposed between the main bodies 20 of each separator 2 and insulating manifold rings 29x and 29y are interposed between the respective gas holes 28x and 28y of each separator 2, thereby providing a fuel cell stack 10 having an external appearance of a substantially rectangular columnar shape which has a fuel gas manifold including the gas hole 28x and the manifold ring 29x; and an air manifold including the gas hole 28y and the manifold ring 29y.

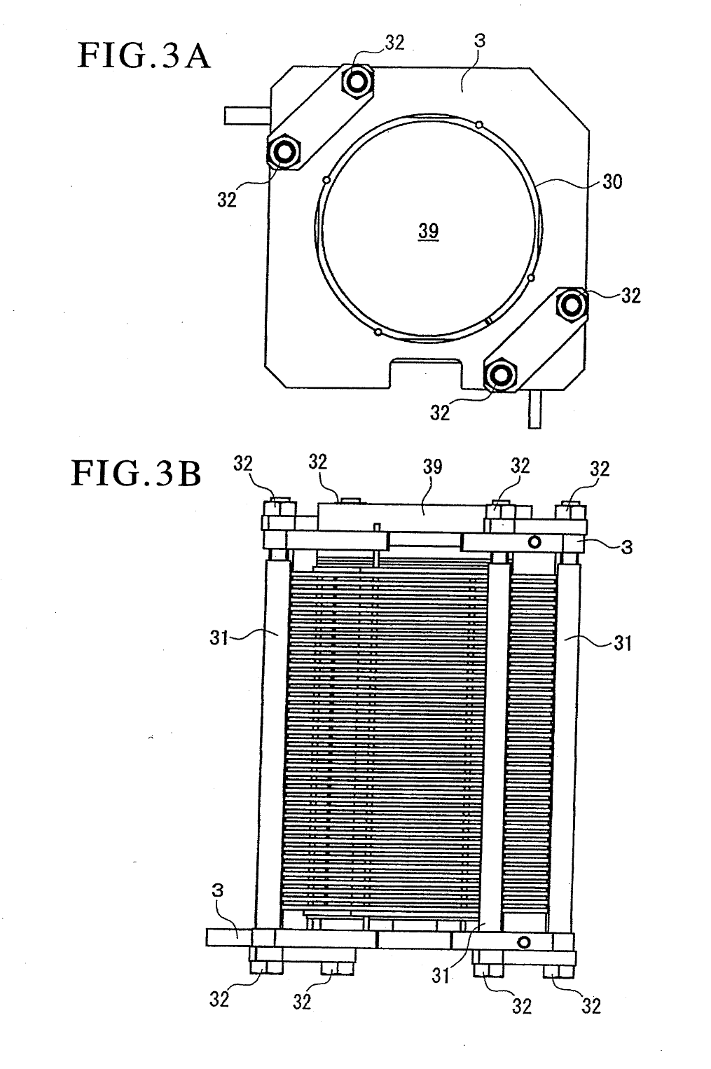

As illustrated in FIGS. 3A and 3B, a flange 3 with an external dimension greater than that of the separator 2 is provided on an upper portion and a lower portion of the fuel cell stack 10. Two bolts 31 each are inserted into two positions corresponding to the manifolds of the flange 3 and the nuts 32 are threadedly fitted in both end portions thereof. The flange 3 and the bolts 31 each threadedly fitting the nuts 32 in both end portions ensure gas sealing of the manifold interposing the above described manifold rings 29x and 29y.

A hole 30 with an external dimension greater than that of the power generation cell 16 is provided in a center portion of the upper flange 3. A weight 39 with substantially the same size as that of the power generation cell 16 placed on the uppermost separator 2 is disposed on the hole 30. The weight 39 ensures mutual adhesion between the separator 2 and the power generation cell 16 sandwiched between the current collectors 14 and 15.

A fuel cell stack 10 configured in this manner is provided in a center portion of an internal can body 5 having a rectangular tube enclosed by four side plates, a top plate, and a bottom plate, and is placed on a rack 51 in such a manner that a large number of fuel cell stacks are arranged in a plane direction so as to form a plurality of rows (two rows in the present embodiment) and a plurality of columns (two columns in the present embodiment) and a plurality of (four in the present embodiment) fuel cell stacks are provided in an up/down height direction. Note that each fuel cell stack 10 is connected to a fuel gas supply line supplying a reformed fuel gas to a fuel gas manifold and an oxidant gas supply line supplying an oxidant gas such as oxygen to an air manifold, and adopts a sealless structure in which at power generation, a reacted gas generated by a reaction between an oxidant gas and a reformed gas and an unreacted gas are released outside as is and the inside of the internal can body 5 can be maintained at a temperature required for power generation by combustion heat of thus released unreacted gas.

Further, the outer periphery of the internal can body 5 is covered with a heat insulating material 50, and inside or near the internal can body 5, a steam generator (not illustrated), a fuel heat exchanger 62, and a reformer 61 are interposedly provided on the above described fuel gas supply line and an air heat exchanger 72 is interposedly provided on oxidant gas supply line. An infrared burner 55 for increasing the internal temperature at start-up is provided on each side plate of the internal can body 5. Thus, the fuel cell is configured such that the reformed gas supplied to the fuel gas manifold is supplied to the fuel electrode layer 12 of the power generation cell 16 of each stack 10, and the oxidant gas supplied to the air manifold is supplied to the oxidant electrode layer 13 of the power generation cell 16 of each stack 1.

According to the flat-plate solid oxide fuel cell of the present embodiment, the solid electrolyte 11 is arranged to project outward from an outer peripheral edge of the fuel electrode current collector 14 and the oxidant electrode current collector 15 over the entire periphery in such a manner that the length of the projecting portion is equal to or greater than 3/100 and equal to or less than 20/100 of the radius of the solid electrolyte. Therefore, this projecting portion 11a can relieve stress such as tensile stress at power generation by being deformed without being constrained by the current collectors 14 and 15. Thus, the present embodiment can prevent a crack from occurring in an outer peripheral portion of the solid electrolyte 11 due to the action of stress.

1. A flat-plate solid oxide fuel cell having a fuel cell stack in which a plurality of power generation cells, each of which has a fuel electrode layer formed on one surface of a disc-shaped solid electrolyte and an oxidant electrode layer formed on the other surface thereof, are laminated by interposing a separator between the power generation cells; and in which a disc-shaped fuel electrode current collector is interposed between the separator and the fuel electrode layer; and a disc-shaped oxidant electrode current collector is interposed between the separator and the oxidant electrode layer,
wherein the solid electrolyte is arranged to project outward from an outer peripheral edge of the fuel electrode current collector and the oxidant electrode current collector over the entire periphery in such a manner that a length of a projecting portion is equal to or greater than 3/100 and equal to or less than 20/100 of the radius of the solid electrolyte.
